(19) United States
(12) Patent Application Publication
(10) Pub. No.: US 2010/0146452 A1
(43) Pub. Date: Jun. 10, 2010

(54) GRAPHICAL USER INTERFACE UNIT FOR PROVISIONING AND EDITING OF BUSINESS INFORMATION IN AN APPLICATION SUPPORTING AN INTERACTION CENTER

(76) Inventors: NICHOLAS ROSE, San Francisco, CA (US); Lap Chan, Dale City, CA (US); Gautam Dharamshi, Sunnyvale, CA (US); Qin He, San Jose, CA (US)

Correspondence Address: SAP AG, 3410 HILLVIEW AVENUE, PALO ALTO, CA, 94304, US

(21) Appl. No.: 12/327,974

(22) Filed: Dec. 4, 2008

(51) Int. Cl. G06F 3/048

(52) U.S. Cl. 715/854

(57) ABSTRACT

A method and a system are described that involve a graphical user interface (GUI) for provisioning and editing of an account's business information in an interaction center. In one embodiment, the GUI includes a navigation panel and a set of predefined navigation links in the navigation panel. The GUI further includes a main screen that displays business information for an account in response to selecting a navigation link from the set of predefined navigation links and an editable table that contains the business information for the account, wherein the editable table is displayed in the main screen.

In another embodiment, the method includes selecting a navigation link from a set of predefined navigation links in a navigation panel. The method further includes displaying business information for an account, within a main screen, in response to selecting the navigation link. And finally, editing the displayed business information according to requests of the account.

### FIELD OF INVENTION

Embodiments of the invention relate generally to the software arts, and, more specifically, to a graphical user interface (GUI) unit of an application for provisioning and editing of information for an interaction center.

### BACKGROUND

Organizations use an interaction center (IC) in a variety of business scenarios including sales, customer service, human resources, and so on. For one company, the IC may be used as an inbound sales center, where agents enter sales orders, answer delivery inquiries, create return material authorizations, or update customer's information. Another company may use the IC to register service requests for internal or external customers, using e-mail and telephone.

The IC can be used in the customer service area enabling agents to streamline the service process. For interaction centers handling inbound service activities, this area provides agents with tools to complete all open processes during the same customer interaction, avoiding unnecessary callbacks. Agents can increase profits by ensuring that service contracts are current and service levels are met. The customer service area includes features such as incorporated easy-to-search knowledge database, account identification, various communication channels, access to customer's data, and so on.

Part of the customer service area is the information help desk. The information help desk is a hub through which problems or issues are reported across multiple communication channels (such as telephone, e-mail, chat, and fax) and subsequently managed and coordinated. It provides interaction center agents with quick and easy access to knowledge bases containing the most current information. On the organization side, the information help desk empowers agents to respond to customers' queries quickly, efficiently, and consistently. This improves agent effectiveness and minimizes costs because issues seldom need to be referred to product or service experts. On the customer side, the convenience with which the customer can contact the information help desk and the fast problem resolution and quality service maximize customer satisfaction and foster valuable and lasting customer relationships.

### SUMMARY

A method and a system that involve a graphical user interface (GUI) for provisioning and editing of an account's business information in an interaction center are described. In one embodiment, the GUI includes a navigation panel and a set of predefined navigation links in the navigation panel. The GUI further includes a main screen that displays business information for an account in response to selecting a navigation link from the set of predefined navigation links and an editable table that contains the business information for the account, wherein the editable table is displayed in the main screen.

In another embodiment, the method includes selecting a navigation link from a set of predefined navigation links in a navigation panel. The method further includes displaying business information for an account, within a main screen, in response to selecting the navigation link. And finally, editing the displayed business information according to requests of the account.

### FIGURES

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flow diagram of an embodiment for handling customer contacts in an interaction center.

FIG. 2 is a screenshot of an embodiment for searching an account in an interaction center.

FIG. 3 is a screenshot of an embodiment of a result list with business partners.

FIG. 4 is a screenshot of an embodiment of a GUI unit with confirmed partners.

FIG. 5 is a screenshot of an embodiment for provisioning and editing of business information via a GUI in an account identification unit.

FIG. 5A is a screenshot of an embodiment for provisioning and editing of contact information of a business partner in a GUI unit.

FIG. 5B is a screenshot of an embodiment for provisioning and editing of history information of a business partner in a GUI unit.

FIG. 5C is a screenshot of an embodiment for provisioning and editing of product information of a business partner in a GUI unit

FIG. 5D is a screenshot of an embodiment for provisioning and editing of contact information of a business partner in a GUI unit.

FIG. 5E is a screenshot of an embodiment for provisioning and editing of installed bases information of a business partner in a GUI unit.

FIG. 5F is a screenshot of an embodiment for provisioning and editing of related partners information of a business partner in a GUI unit.

### DETAILED DESCRIPTION

Embodiments of the invention relate to a system and method including a graphical user interface (GUI) unit of an application for provisioning and editing of business information for an interaction center.

In one embodiment, an interaction center provides customer support to users. Each user is registered with an account in the interaction center. When the user contacts the information help desk at the interaction center, or the customer support department, the user is first identified by the details stored in his or her account. When the account is confirmed, the system provides information about that customer or contact person, such as address, open orders, or past interaction details. It is important for the account to be identified in the system as this allows to easily record interactions in the right place, thus, making it easier to provide correct information the next time the customer contacts the business company.

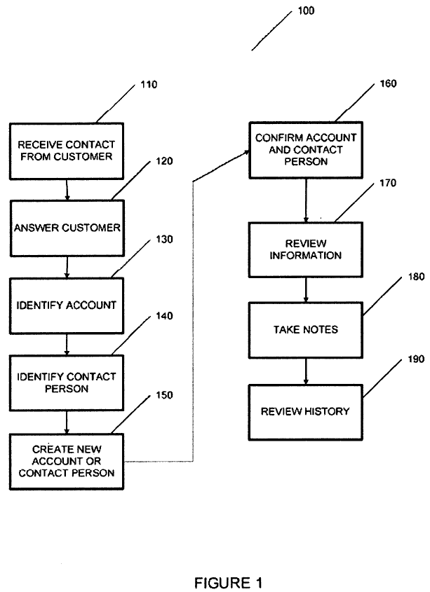

FIG. 1 is a flow diagram of an embodiment for handling customer contacts in an interaction center. Process 100 includes a number of steps through which account or product identification is performed in the interaction center. At block 110, a contact by a customer is received at the center. The contact may be received via a phone call, a chat request, an e-mail, and so on. At block 120, an agent of the interaction center (IC) answers the contact. If the telephony switch system of the IC has automatic number identification (ANI), the system can identify customers even before the agent accepts the contact. The ANI is a telephone network feature that passes, in real time, the caller's telephone number to the call center. At block 130, the customer's account is identified either automatically by the system or by the agent. The account may be identified by the system using the customer's telephone number or e-mail address to match the contact to an existing account or by the agent using manual search for the account. In an embodiment, a search may be performed for identifying not only a person, but a specific product or a sales order.

At block 140, a contact person is identified for the corresponding account. For one account, there may be more than one contact persons. If the account or contact person is not identified, a new account or contact person is created at block 150. At block 160, the account and contact person are confirmed. When an account or product is confirmed, the system displays all relevant information for the account or product on the screen. This information is also recorded in a virtual, central data storage area in the IC and can be reused later. At block 170, detailed information about the account or product can be reviewed. This information may include contacts, addresses, phone numbers, history, alerts, and so on. The information provides an immediate and condensed overview of data about business partners taken from several sources such as business partner master data, statistical data, and transaction data.

In an embodiment, a system administrator of the IC may define alerts to be triggered by various system events. Depending on the alert, appropriate measures can be taken by the agent. Alerts use information available in the system to provide agents with information that they may need at critical points in customer interactions. At block 180, the agent can take some notes during the interaction. At block 190, history of previous interactions can be reviewed. Details about the current interaction can be recorded in the current account for future reference.

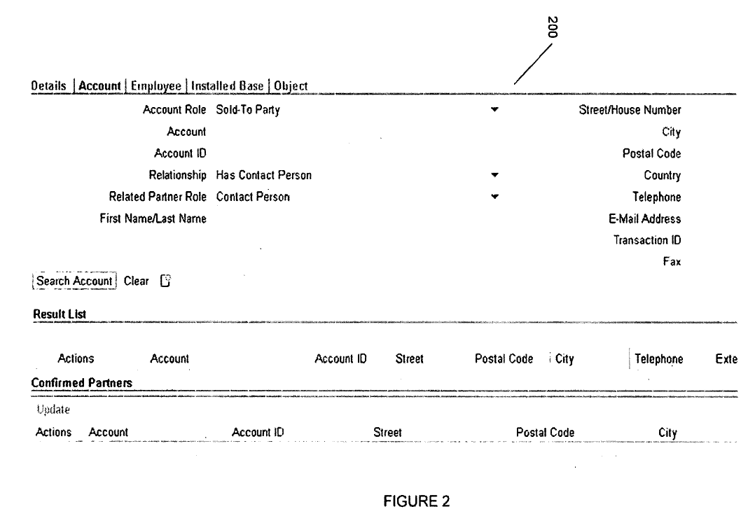

FIGS. 2-4 represent a flow of screenshots of an embodiment for identifying an account in an interaction center. The interaction center uses an application to identify, record, and work with accounts of business partners. A business partner is a person or organization with which a company has business relations. A business partner is defined by the associated address master data, such as name, postal address, e-mail, telephone number, fax number, etc.

FIG. 2 is a screenshot of an embodiment for searching an account in an interaction center. In an embodiment, when the system of the interaction center does not automatically identify a business partner's account and contact person, an agent of the interaction center has to perform a search manually. The search can be performed using information obtained from the customer during the interaction. Screenshot 200 shows a number of fields that can be used by an agent to search an account. For example, the agent can ask the customer for an account name, an account identification number (ID), first and/or last name, postal address, e-mail, phone number, and so on. Only one of these criteria is enough for performing the search. For example, the agent can enter account ID such as “3277”. The agent selects the Search Account button to complete the search.

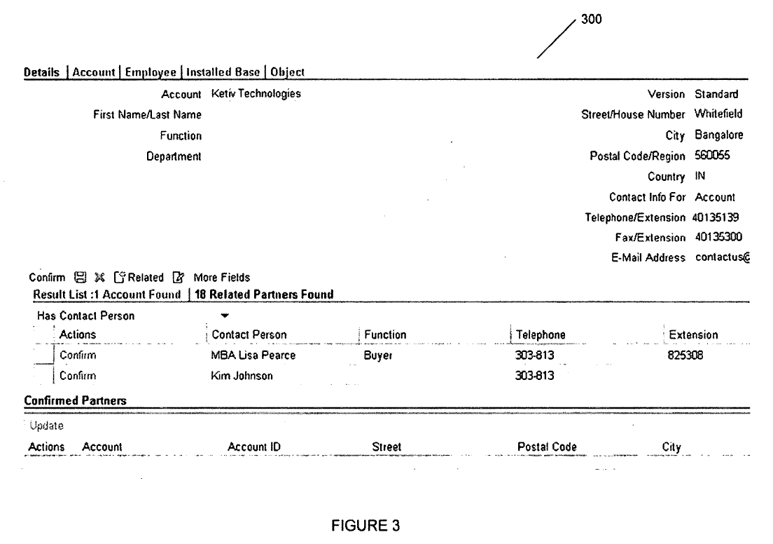

FIG. 3 is a screenshot of an embodiment of a result list with business partners. The result list is a table that contains a number of business partners presented with basic information such as account name, account ID, address, and phone. This information should be sufficient for the agent to identify and confirm the business partner. In an embodiment, there may be no business partners available in the system of the IC and the result list will be empty. In this case, the agent can create a new account for the corresponding customer (or business partner). In another embodiment, only one business partner can be found by the system according to the search criteria. In this case, the business partner is automatically confirmed by the system and all related partners for the business partner's account are listed in a GUI table. Screenshot 300 presents a table with some basic details for all related partners found for account: “Ketiv Technologies”, this account was found in response to entering “3277” as an account ID. The agent can easily find the contact person or related partner for this account and confirm it.

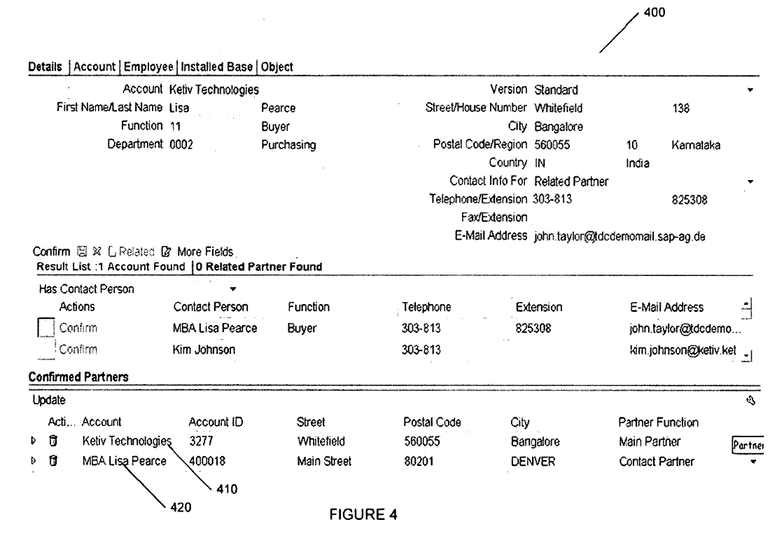

FIG. 4 is a screenshot of an embodiment of a GUI unit with confirmed partners. Screenshot 400 presents a list of confirmed accounts of business partners and contact persons or related partners to the business partner. For example, Ketiv Technologies 410 is the confirmed account of the business partner Ketiv Technologies. Ketiv Technologies 410 is listed with account ID, postal address, and as a main partner. MBA Lisa Pearce 420 is a confirmed related partner for the Ketiv Technologies 410 account. MBA Lisa Pearce 420 is listed as a contact partner (i.e., contact person for this account). After the contact person involved in the current interaction is confirmed (for example, Lisa Pearce), the agent can see detailed information for the contact person and perform any required services.

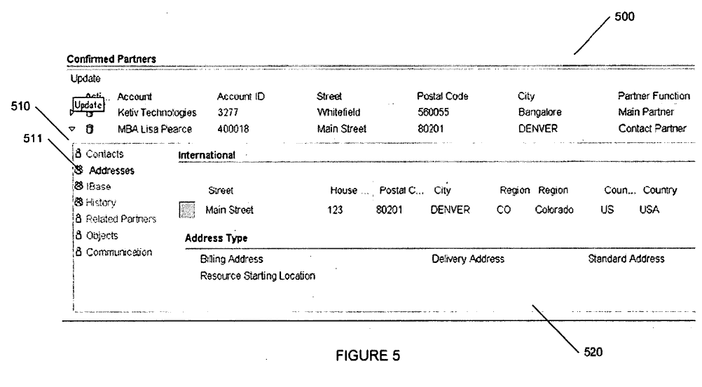

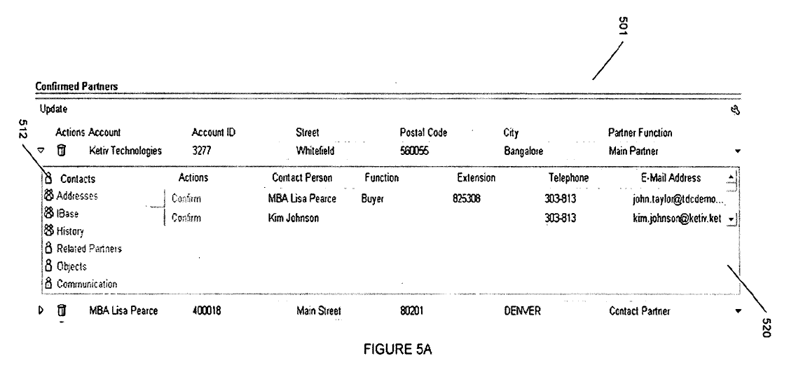

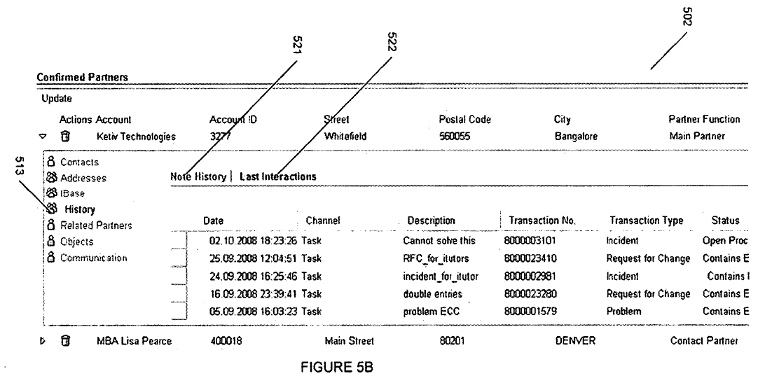

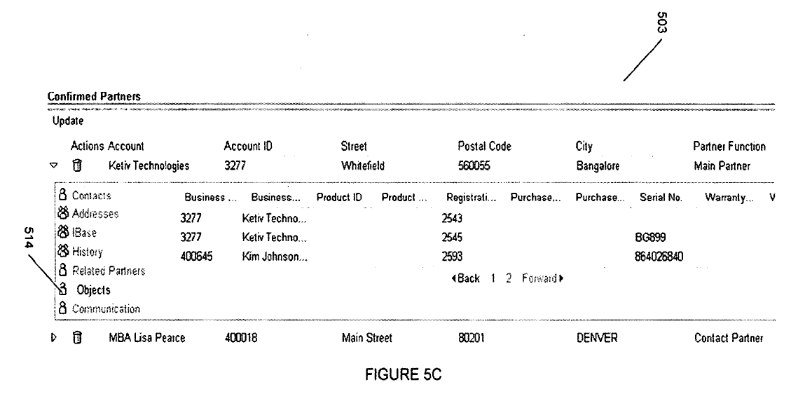

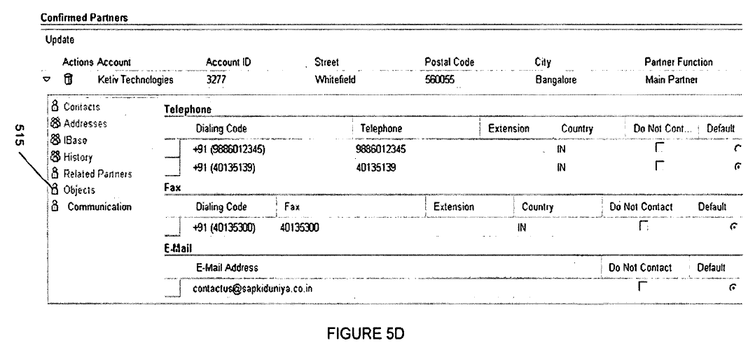

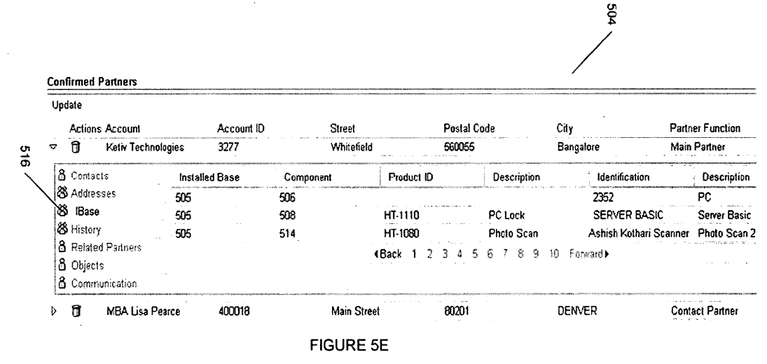

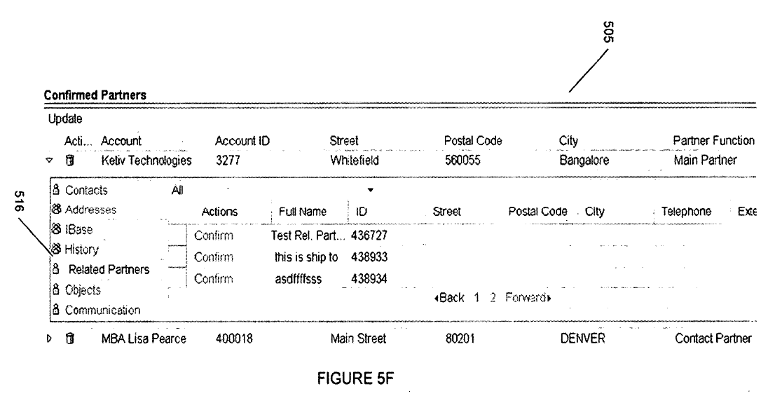

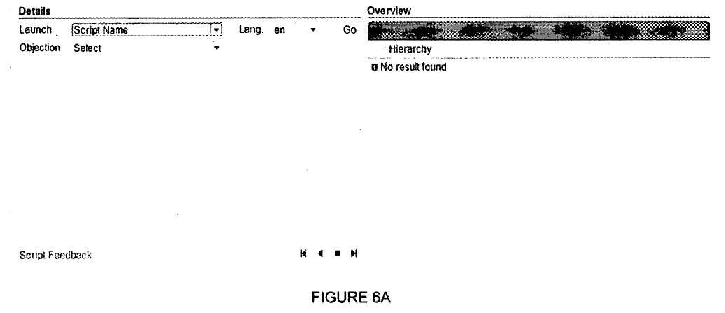

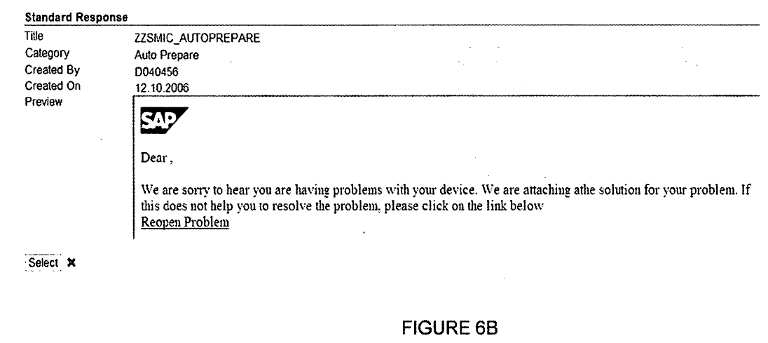

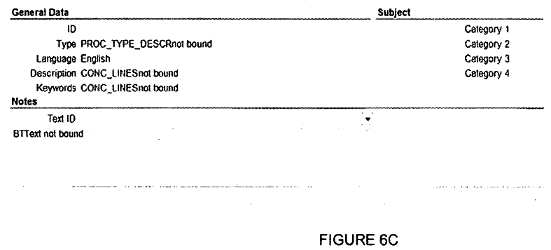

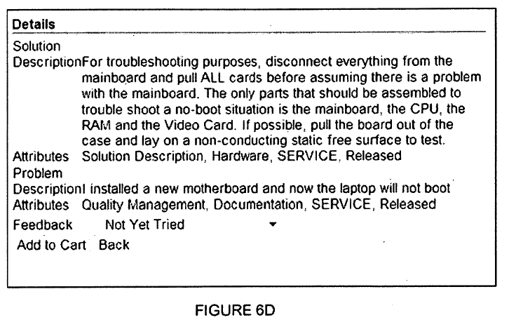

FIG. 5 is a screenshot of an embodiment for provisioning and editing of business information via a GUI in an account identification unit. Screenshot 500 presents a GUI unit for provisioning and editing of detailed information for a confirmed business partner. The GUI unit is part of the account identification process of an interaction center. The GUI includes a navigation panel 510 with a set of navigation links and a main screen 520 that displays information for the business partner in response to selecting a navigation link from the navigation panel 510. In an embodiment, the navigation panel 510 includes a set of predefined navigation links such as contacts, addresses, related partners, history, communication, and so on. The navigation links are defined and integrated in the GUI unit during modeling phase of the application. The navigation links provide detailed information for a business partner and allow the user, such as the agent of the interaction center, to revise past interactions with the same business partner and take actions. This information is displayed on only one screen, i.e., the main screen 520, by passing over (for example, clicking with the mouse) from one navigation link to another in the navigation panel 510. Thus, the application GUI unit saves the user time and orientation from following a flow of screens of information to complete a simple task. The GUI unit is modeled in such a way to enable more viewable space on the screen, which allows more functions to be included and performed on the same screen by the user. The navigation links of the navigation panel 510 can be modified according to the needs of the user, i.e., the agent in the interaction center. If the agent needs additional information for the business partner, which is not available with the provided navigation links, then the GUI unit can be remodeled to include such information in the form of additional navigation links.

Screenshot 500 shows the GUI unit for provisioning of business information with the Addresses 511 navigation link selected. Main screen 520 displays the current postal address of the business partner. The user can also see the type of the address, i.e., if the address is a billing address, a delivery address, a standard postal address, and so on. In an embodiment, the business partner that contacted the interaction center may want to change the current postal address or its type. In another embodiment, the business partner may want to add a new address for a new purpose, for example, to add a delivery address. The GUI is editable and allows the agent to perform the desired operations and save the new data.

FIG. 5A is a screenshot of an embodiment for provisioning and editing of contact information of a business partner in a GUI unit. Screenshot 501 shows the GUI unit for provisioning and editing of business information with the Contacts 512 navigation link selected. The stored contact persons of a particular business partner are listed in a table located in main screen 520. The agent of the interaction center can create a new contact person or confirm another contact person for the same business partner. In addition, the agent can select a contact person from the list and view or edit the stored information for this contact person.

FIG. 5B is a screenshot of an embodiment for provisioning and editing of history information of a business partner in a GUI unit. Screenshot 502 shows the GUI unit for provisioning and editing of business information with the History 513 navigation link selected. Main screen 520 contains two screen areas: note history 521 and last interactions 522. Note history 521 contains all notes taken by the agent during the previous interactions with the current business partner. Last interactions 522 screen area contains a list of the last interactions between the center and the current business partner. The interactions are recorded with a timestamp, description, transaction number, type of the interaction, status, and so on. The agent of the interaction center can create a new note for the current interaction. In addition, the current interaction will be added to the list of last interactions after the agent serves the business partner.

FIG. 5C is a screenshot of an embodiment for provisioning and editing of product information of a business partner in a GUI unit. Screenshot 503 shows the GUI unit for provisioning and editing of business information with the Objects 514 navigation link selected. Main screen 520 contains a table with product information for a business partner such as, but not limited to, product ID, product description, registration ID, purchase location, purchase date, serial number, warranty valid from date, and warranty valid to date. The table lists the products that were purchased by a particular business partner. The agent of the interaction center can review the stored information.

FIG. 5D is a screenshot of an embodiment for provisioning and editing of contact information of a business partner in a GUI unit. Screenshot 503 shows the GUI unit for provisioning and editing of business information with the Communication 515 navigation link selected. Main screen 520 contains a table with contact information for a specific business partner such as, but not limited to, telephone numbers, fax numbers, and e-mail addresses. The agent of the interaction center can view and change the entered information upon a request from the business partner during the interaction.

FIG. 5E is a screenshot of an embodiment for provisioning and editing of installed bases information of a business partner in a GUI unit. Screenshot 504 shows the GUI unit for provisioning and editing of business information with the IBase 516 navigation link selected. In an embodiment, the interaction center may store information for an installed base of a business partner. The installed base may include different components and products, such as a personal computer, a photo scanner, a server machine, and so on. The installed components are listed in the main screen 520.

FIG. 5F is a screenshot of an embodiment for provisioning and editing of related partners information of a business partner in a GUI unit. Screenshot 505 shows the GUI unit for provisioning and editing of business information with the Related Partners 517 navigation link selected. Main screen 520 lists the business partners related to the current business partner in the interaction. The related business partners are listed with contact information such as, but not limited to, a full name, an identification number, a postal address, and a phone number.

It should be appreciated that various data for a business partner can be included in the GUI unit for provisioning and editing of business information. The described data provided by the navigation links is only an example of such functionality. The navigation links can be changed and replaced with other navigation links that point to different business information. The business information may also concern sales orders, products, customers, etc., not only business partners.

The GUI unit for provisioning of business information can be used in chat scenarios as well. In an embodiment, the interaction center (IC) allows the agent to increase customer service and satisfaction by being able to search multiple knowledge bases. Knowledge search is a functionality provided by the IC. Agents use the knowledge search to find solutions to problems or other issues that are reported by customers through channels such as telephone, e-mail, and chat. This enables the agent to provide more complete answers and information to the customer immediately. The agent can receive a chat request from a customer. Then, the IC agent can accept that request and begin a communication with the customer through the IC chat functionality.

FIG. 6A is a screenshot of an embodiment for provisioning of script records for a business partner within a search result list. The scripts guide an agent through interactions with customers. Scripts are made up of interconnected lists of questions and possible answers. When working through the script, agents ask customers the questions that appear and indicate their responses, which are recorded in the system. System administrators assign these scripts to a profile of a customer, such as an account of a business partner within the IC. The agent can perform a search for launching a particular script. The GUI unit for provisioning and editing of business information displays the script in the result list. The agent is able to perform the script and ask the business partner the questions that appear in the script and indicate the responses.

FIGS. 6B-6D are screenshots of embodiments of a GUI unit included in a search result list for provisioning and editing of business information for a business partner. FIG. 6B is a screenshot of an embodiment for provisioning of a mail form. In an embodiment, the agent of the IC can search the knowledge bases for a particular e-mail form to send to a customer during a chat interaction with the same customer. The e-mail form is displayed directly in the search result list. The form can be a standard response to a problem, a template for a specific issue, a blank form, and so on. The agent is able to edit the e-mail text before sending it to the customer. The data provided with the e-mail form may include: title of the form; category; created by—the user in the IC who created the form; created on—the date on which the form was created; a preview of the form itself, etc. FIG. 6C is a screenshot of an embodiment for provisioning of a knowledge article. The knowledge article is stored in a knowledge database. The agent performs a search for a particular knowledge article that wants to send to a business partner during an interaction (e.g., a chat interaction). The article is displayed in the search result list with basic information such as description, language, type, ID, and so on. FIG. 6D is a screenshot of an embodiment for provisioning of a knowledge search solution. The agent of the IC can perform a search the knowledge bases for a solution of a particular problem during an interaction with a customer or business partner. It may contain a solution description text, attributes that classify the solution in specific categories, problem description, attributes for the problem, feedback, and so on. The solution is displayed in GUI unit directly in the search result list table. In another embodiment, the agent can find a previous chat transcript of a chat interaction with a customer. The agent can open the chat transcript to see details related to the previous discussion. The chat transcript is displayed within the knowledge search results table.

The GUI unit for provisioning and editing of business information organized in this way enables a quick and easy access to the business information of a customer from an agent of an interaction center (for example, a call center). Moreover, the business information is provided during account identification, interaction with the customer (e.g., chat, telephone call, etc.), or similar business functions performed in a support center, interaction center, help desk, and so on. The most needed data is displayed directly in the search results and the agent is able to see on one screen the customers that are waiting in the queue for service, the confirmed customers, and the detailed information for a particular customer. Thus, the agent saves time in reviewing and editing the customer's data and increases the performance of his or her daily tasks.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program, which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. In a computer system having a GUI, a method for providing business information in an interaction center, comprising:
selecting a navigation link from a set of predefined navigation links in a navigation panel;
displaying business information for an account, within a main screen, in response to selecting the navigation link; and
editing the displayed business information according to requests of the account.

2. The method of claim 1, wherein a current contact between the account and the interaction center is established.

3. The method of claim 2, wherein the current contact is established via a communication channel selected from the group consisting of a telephone call, an e-mail address, and a chat request.

4. The method of claim 1, wherein the predefined navigation links can be modified to display different business information for the account.

5. The method of claim 1 further comprising:
confirming a contact person for the account; and
confirming a related business partner for the account.

6. The method of claim 1, wherein displaying business information comprises:
displaying purchase orders information for the account;
displaying last interactions between the account and the interaction center; and
displaying history of notes taken during the last interactions.

7. The method of claim 1, wherein editing the displayed business information comprises:
modifying contact information for the account.

8. The method of claim 1, further comprising:
displaying multiple accounts on the GUI, the multiple accounts waiting for service by the interaction center.

9. The method of claim 1, further comprising:
displaying information into a search results table on the GUI, the information selected from the group consisting of a mail form, a knowledge article, a script, a knowledge search solution, and a chat transcript.

10. A graphical user interface (GUI) for providing business information in an interaction center, comprising:
a navigation panel;
a set of predefined navigation links in the navigation panel; and
a main screen that displays business information for an account in response to selecting a navigation link from the set of predefined navigation links.

11. The GUI of claim 10, wherein the account is in a current contact with the interaction center.

12. The GUI of claim 10, wherein the main screen comprises:
an editable table that contains the business information for the account, wherein the editable table is displayed in the main screen.

13. A machine-readable medium having a program code stored thereon which, when executed by a machine, causes the machine to:
select a navigation link from a set of predefined navigation links in a navigation panel;
display business information for an account, within a main screen, in response to selecting the navigation link; and
edit the displayed business information according to requests of the account.

14. The machine-readable medium of claim 13, wherein a current between the account and the interaction center is established.

15. The machine-readable medium of claim 14, wherein the current contact is established via a communication channel selected from the group consisting of a telephone call, an e-mail address, and a chat request.

16. The machine-readable medium of claim 13, wherein the predefined navigation links can be modified to display different business information for the account.

17. The machine-readable medium of claim 13 having instructions that when executed further cause the machine to:
confirm a contact person for the account; and
confirm a related business partner for the account.

18. The machine-readable medium of claim 13 wherein instructions causing the machine to display business information comprise instructions causing the machine to:
display purchase orders information for the account;
display last interactions between the account and the interaction center; and
display history of notes taken during the last interactions.

19. The machine-readable medium of claim 13 wherein instructions causing the machine to edit the displayed business information comprise instructions causing the machine to:
modify contact information for the account.

20. The machine-readable medium of claim 13 having instructions that when executed further cause the machine to:
display multiple accounts on the GUI, the multiple accounts waiting for service by the interaction center.

21. The machine-readable medium of claim 13 having instructions that when executed further cause the machine to:
display information into a search results table on the GUI, the information selected from the group consisting of a mail form, a knowledge article, a script, a knowledge search solution, and a chat transcript.

22. A machine-readable medium having a program code stored thereon which, when executed by a machine, causes the machine to render a graphical user interface (GUI), the GUI comprising:
a navigation panel;
a set of predefined navigation links in the navigation panel;
a main screen that displays business information for an account in response to selecting a navigation link from the set of predefined navigation links; and
an editable table that contains the business information for the account, wherein the editable table is displayed in the main screen.
